(19) United States
(12) Patent Application Publication
(10) Pub. No.: US 2017/0344955 A1
(43) Pub. Date: Nov. 30, 2017

(54) MOBILE TERMINAL AND METHOD FOR CONTROLLING SAME

(71) Applicant: LG ELECTRONICS INC., Seoul (KR)

(72) Inventors: Hyehyun KIM, Seoul (KR); Jayoung SHIN, Seoul (KR); Sujung KIM, Seoul (KR); Ramchan WOO, Seoul (KR); Haelie KWAK, Seoul (KR); Kyungjin YOU, Seoul (KR); Youngkyu CHO, Seoul (KR); Jay HAN, Seoul (KR); Jinhae CHOI, Seoul (KR); Jisoon PARK, Seoul (KR); Hyeji AN, Seoul (KR)

(73) Assignee: LG ELECTRONICS INC., Seoul (KR)

(21) Appl. No.: 15/529,452

(22) PCT Filed: Oct. 29, 2015
(86) PCT No.: PCT/KR2015/011491

§ 371 Date: May 24, 2017

Related U.S. Application Data
(60) Provisional application No. 62/084,371, filed on Nov. 25, 2014.

(30) Foreign Application Priority Data
Jan. 26, 2015 (KR) 10-2015-0012342

(51) Int. Cl. G06Q 10/10; G06F 3/0488; G06F 3/0486

(52) U.S. Cl. CPC G06Q 10/1093; G06F 3/0486; G06F 3/0488

(57) ABSTRACT

Provided are a mobile terminal and a method for controlling the mobile terminal. A mobile terminal according to one embodiment of the present invention allows the user to add a desired event to a scheduler more easily and conveniently by providing together with the scheduler a window for recommending an event that may be added to the scheduler.

### TECHNICAL FIELD

The present invention relates to a mobile terminal and a method for controlling the mobile terminal.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

### DISCLOSURE

### Technical Problem

An object of the present invention is to provide a mobile terminal providing a user interface by which a user may control the mobile terminal in an easy and efficient manner and a method for controlling the mobile terminal.

Also, an object of the present invention is to provide a mobile terminal capable of improving efficiency of schedule management, by which a user may register a desired event more conveniently on a scheduler execution screen of the mobile terminal in case the user wants to register the event in the scheduler and a method for controlling the mobile terminal.

### Technical Solution

A mobile terminal according to one aspect of the present invention comprises a touch screen; a memory grouping and storing at least one event; and a controller displaying a scheduler on the touch screen by executing a scheduler application, in case a predetermined input is received, displaying on the touch screen a window for recommending at least one event that may be registered in the scheduler so that at least part of the window may overlap with the scheduler, in case an input associating a specific event from among at least one event displayed on the window with the scheduler is received, registering the specific event to a specific schedule of the scheduler.

The grouped at least one event may be grouped directly by the user and stored in a predetermined folder, and grouped items may be retrieved by a scheduler application and registered freely to a desired schedule. The events grouped and managed by the user may include at least one of an image, web page, or memo.

The window may be displayed being slid from one side of the touch screen. In case an input selecting a specific event from among at least one event displayed on the window is received, the controller makes the window disappear while the selected specific event is retained, while, in case an input dragging the specific event to a specific schedule of the scheduler is received, the controller may register the specific event to the specific schedule.

At least one event that may be registered to the scheduler may correspond to data including a schedule.

The scheduler is provided in a calendar-type interface, and in case an input moving a specific event from among at least one event displayed on the window to the scheduler is received, the controller may register the specific event to the schedule corresponding to the specific event through the calendar-type interface.

In case an event of the past schedule with respect to the current time is registered to a specific schedule of the scheduler, the controller may display on the touch screen a pop-up message notifying that the event may not be registered or in case an event of the past schedule [U1] is registered to the scheduler, display on the touch screen an indicator by which the registered event may be deleted.

The window may categorize the source of at least one event that may be registered to the scheduler, where the source may include a first category including the at least one event grouped by the user, a second category including an SNS, a third category providing an event based on location information, and a fourth category including a task generated by the user.

In case a first event registered to the SNS is selected by the user as an event of interest, the controller may store the first event by classifying the first event to the second category.

In case the second category is selected, the controller may extract an event having an event from among the events uploaded to the SNS and provide the extracted event to the window.

In case an input dragging the event registered to the scheduler into the window is received, the controller may delete the registered event from the schedule.

A method for controlling a mobile terminal according to another aspect of the present invention comprises displaying a scheduler on a touch screen by executing a scheduler application; in case a predetermined input is received, displaying a window for recommending at least one event that may be registered in the scheduler so that at least part of the window may overlap with the scheduler by being slid from one side of the touch screen; in case an input selecting a specific event from among at least one event displayed on the window is received, making the window disappear while the selected specific event is retained; and in case an input dragging the specific event into a specific schedule of the scheduler is received, registering the specific event to the specific schedule.

### Advantageous Effects

An object of the present invention is to provide a mobile terminal providing a user interface by which a user may control the mobile terminal in an easy and efficient manner and a method for controlling the mobile terminal.

Also, an object of the present invention is to provide a mobile terminal capable of improving efficiency of schedule management, by which a user may register a desired event more conveniently on a scheduler execution screen of the mobile terminal in case the user wants to register the event in the scheduler and a method for controlling the mobile terminal.

### DESCRIPTION OF DRAWINGS

FIG. 1 is a block diagram of a mobile terminal in accordance with the present disclosure.

FIG. 2 illustrates a flow diagram of a method for controlling a mobile terminal according to one embodiment of the present invention.

FIGS. 3 to 4 illustrate an example of an execution screen of a scheduler application according to one embodiment of the present invention.

FIG. 5 illustrates an example of an interface for adding a predetermined event to a scheduler according to one embodiment of the present invention.

FIGS. 6a to 6d illustrate an example of grouping events to be added to a scheduler according to one embodiment of the present invention.

FIGS. 7 to 8 illustrate an example of a procedure for adding an event to a scheduler according to one embodiment of the present invention.

FIG. 9 illustrates an example of displaying grouped items of FIG. 6 together with a scheduler.

FIG. 10 illustrates another example of generating an event to be added to a scheduler according to one embodiment of the present invention.

FIGS. 11 to 12 illustrate an example of registering an event of a first category to a scheduler according to one embodiment of the present invention.

FIGS. 13a to 14b illustrate an example of registering an event of a second category to a scheduler according to one embodiment of the present invention.

FIGS. 15a to 17b illustrate an example of registering an event of a third category to a scheduler according to one embodiment of the present invention.

FIGS. 18a to 18b illustrate an example of registering an event of a fourth category to a scheduler according to one embodiment of the present invention.

FIGS. 19 to 20 illustrate an example of editing an event to be added to a scheduler or an event registered to the scheduler according to one embodiment of the present invention.

### BEST MODE

### Mode for Invention

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

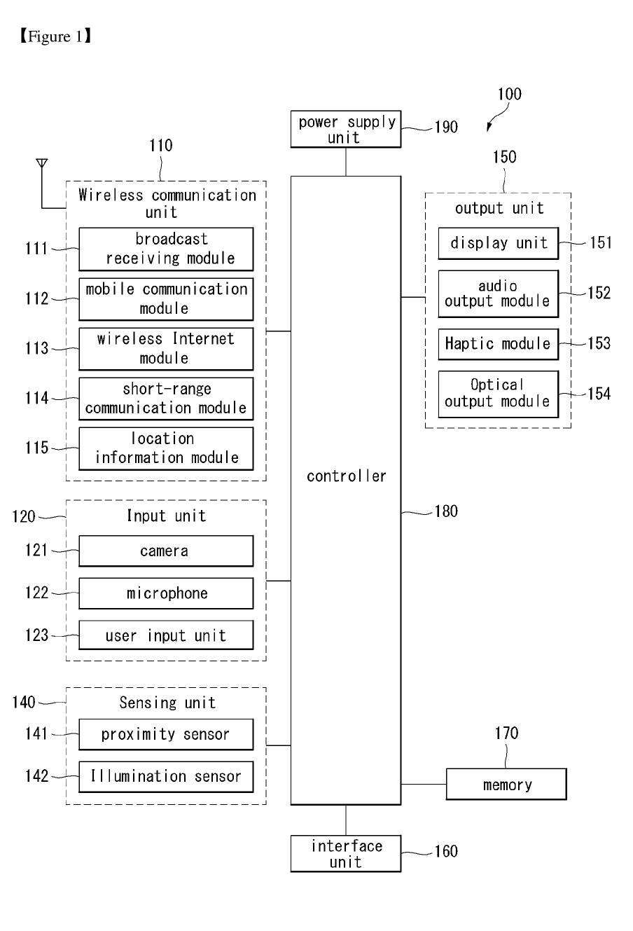

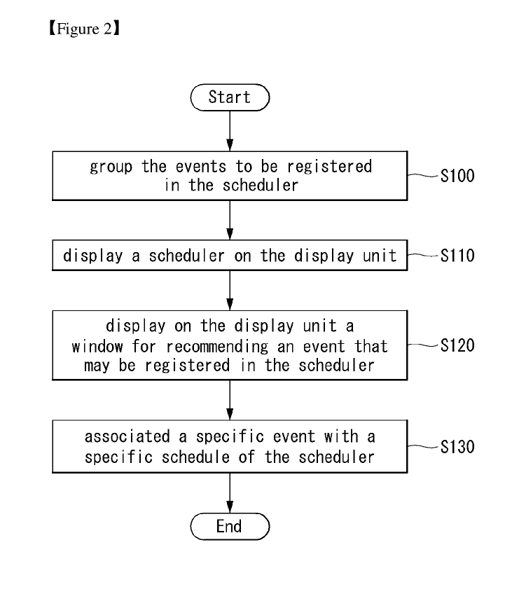

Reference is now made to FIGS. 1, where FIG. 1 is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE) , LTE-A(Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Further preferred embodiments will be described in more detail with reference to additional drawing figures. It is understood by those skilled in the art that the present features can be embodied in several forms without departing from the characteristics thereof.

FIG. 2 illustrates a flow diagram of a method for controlling a mobile terminal according to one embodiment of the present invention.

Referring to FIG. 2, the controller 180 of the mobile terminal 100 may group the events to be registered in the scheduler S100.

The controller 180 may store the event desired by the user into a predetermined folder according to a user input. The user may perform grouping of events irrespective of whether or not the scheduler is running For example, while using a different application, the user may set the contents provided by the application as an event to be added to the scheduler.

Examples of events to be registered in the scheduler may include an image, memo, SNS event provided by a social network service, event based on location information, and event set by the user.

Meanwhile, the event that may be registered in the scheduler may include schedule information (for example, time information comprising year, month, and day). Since the scheduler operates on a time-base, it is preferable for an event to have schedule information if the event is to be added to the scheduler. However, the present invention is not limited to the description above.

For example, an event that may be registered in the scheduler may include a specific task set by the user independently of a specific schedule. In other words, an event that does not have schedule information may become an event having schedule information as the user adds the event to the scheduler according to one embodiment of the present invention. The type of event that does not have schedule information may be a specific task set by the user as described above, but the event may be an image. In the case of image, an event may include a thumbnail image corresponding to event information with schedule information.

The controller 180 may display a scheduler on the display unit 151 by executing a scheduler application S110.

The scheduler may be provided in a calendar-type interface, and the view mode of the calendar-type interface may be provided in the form of year, month, and day. The calendar-type interface may be displayed as a list composed of rows and columns.

The controller 180 may display on the display unit 151 a window for recommending an event that may be registered in the scheduler.

The window may be provided in the form of a bar. The window may be provided so that part of the window is overlapped with the scheduler by being slid from one side of the touch screen 151 according to a predetermined input.

The controller 180 may control a specific event through the window so that the specific event may be associated with a specific schedule of the scheduler S130.

The operation for associating the specific event with a specific schedule of the scheduler will be described in more detail with reference to appended drawings. Meanwhile, if a specific event is associated with the scheduler, a thumbnail image corresponding to the specific event may be displayed on a specific schedule of the scheduler to visualize the association.

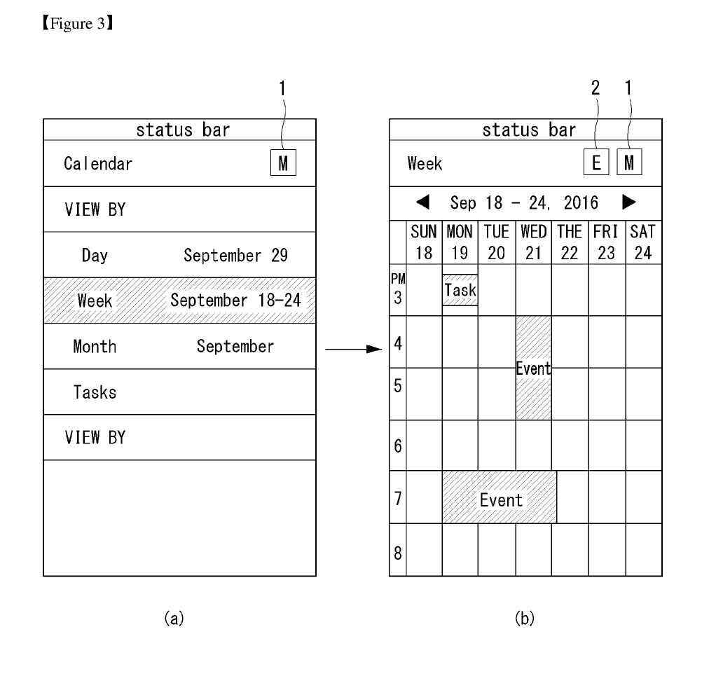

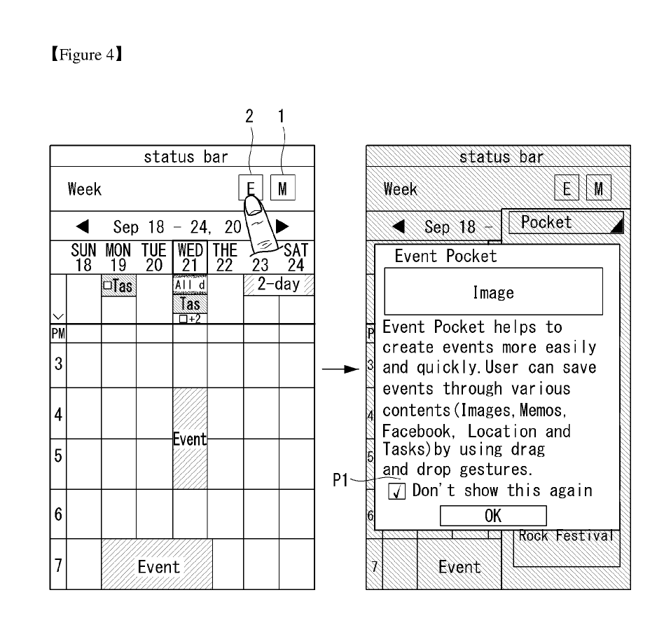

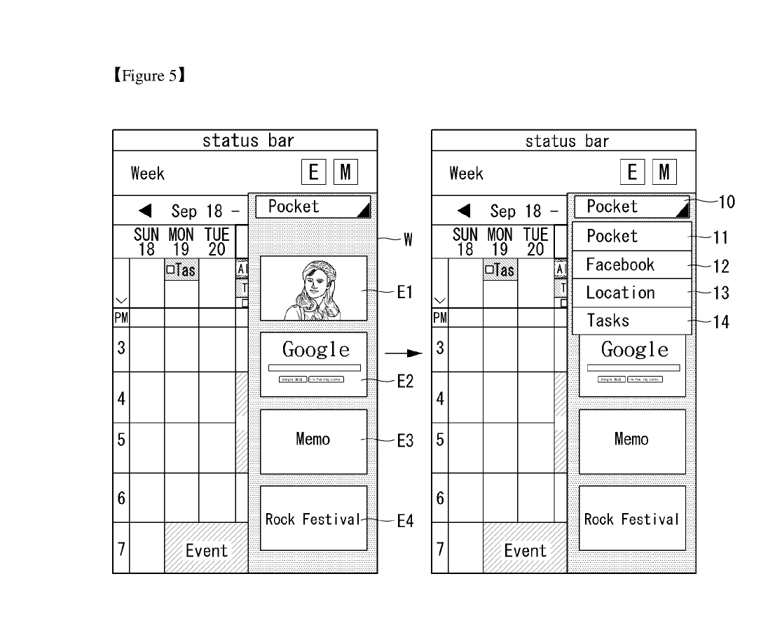

FIGS. 3 to 4 illustrate an example of an execution screen of a scheduler application according to one embodiment of the present invention.

Referring to FIG. 3(a), if a scheduler application is executed, the controller 180 may display a menu icon 1 for configuring a view mode of the scheduler on the touch screen 151. If the menu icon 1 is selected, menus for selecting the view mode of the scheduler may be displayed. In other words, as menus corresponding respectively to day, week, and month are selected, the user may control displaying of the scheduler according to a selected view mode.

Meanwhile, the menu may further include a task item. A task menu may be used to provide events not registered in the scheduler as schedules but prepared in advance to be added to a specific schedule of the scheduler. For example, in case the user stores specific contents in a task folder while using the mobile terminal 100, the specific contents may be added to a specific schedule of the scheduler by providing the specific contents on the scheduler screen after the scheduler is executed.

Referring to FIG. 3(b), in case a weekly view mode is selected from the menu for selecting a view mode, the controller 180 may display on the touch screen 151 a scheduler screen organized according to weekly schedules.

The scheduler screen may include a window icon 2 for displaying a window for recommending at least one event that may be registered in the scheduler.

Meanwhile, the scheduler screen displays information of events registered to specific schedules. For example, it may be checked from graphic objects mapped to the scheduler that a specific task and events have been registered to specific date and time.

FIG. 4 shows the initial screen P1 when a window icon 2 is selected after a scheduler application is installed. In other words, the window allows the user to register such events as an image, memo, SNS, and task easily in the scheduler through a dragging input of the user.

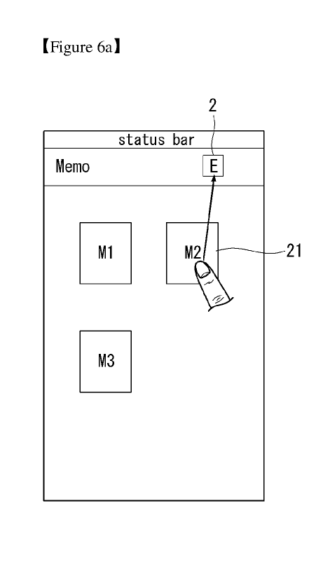

FIG. 5 illustrates an example of an interface for adding a predetermined event to a scheduler according to one embodiment of the present invention.

Referring to FIG. 5, in case an input selecting the window icon 2 is received, a window W including at least one event that may be registered in the scheduler may be displayed being slid from the edge of a side surface of the touch screen 151.

The window W may include at least one event E1, E2, E3, E4, E5.

The first event E1 included in the window W may be an image. The image is a thumbnail image of a specific event to which schedule information is mapped; the schedule information may be mapped as meta information and stored in the thumbnail image. The second event E1 may correspond to a web-page. Link information corresponding to a web-page address may be provided by being mapped to the second event E2. The third event E3 may be a memo, and the fourth event E4 may be an event registered in the SNS.

Meanwhile, according to one embodiment of the present invention, the window W may provide an event that may be registered in the scheduler by categorizing the source of the event. For example, a first category (pocket, 11) may include at least one event grouped by the user. The second category (Facebook, 12) may comprise events provided through SNS services. The third category (Location, 13) may comprise events provided based on location information. The fourth category (Tasks, 14) may comprise events generated directly by the user.

The user may select a category from among a plurality of categories provided through the window W and register an event recommended through the corresponding category in the scheduler.

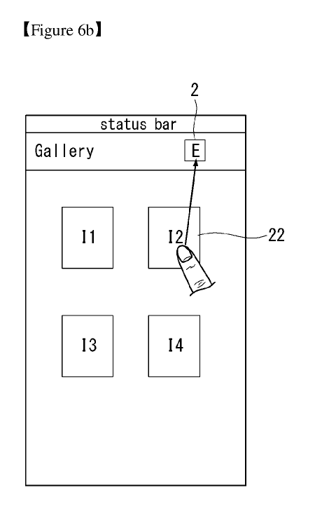

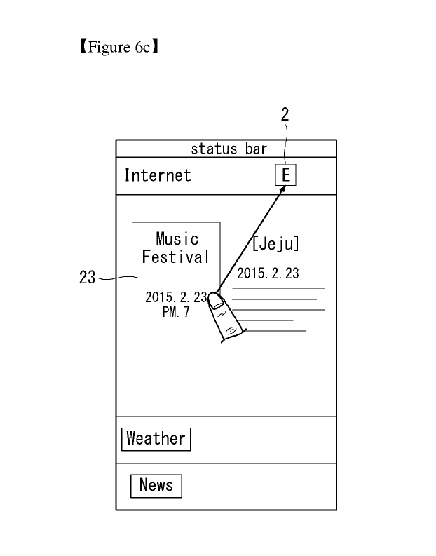

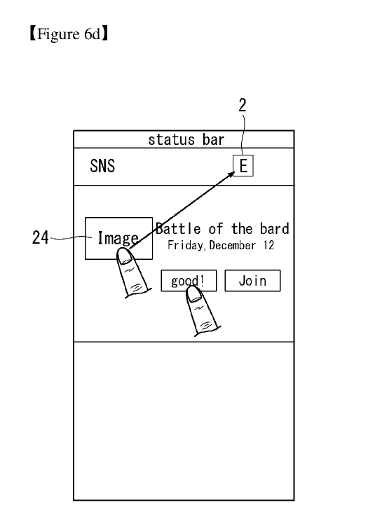

As described above, the first category may include at least one event grouped by the user, which an example of forming the first category is described below with reference to FIGS. 6a to 6d.

FIGS. 6a to 6d illustrate an example of grouping events to be added to a scheduler according to one embodiment of the present invention.

In case a scheduler application according to one embodiment of the present invention is installed, the scheduler application may be linked to another application executed in the mobile terminal 100. Therefore, contents provided according to the execution of a specific application may be associated with the scheduler application. Meanwhile, a window icon 2 for indicating that a specific application is associated with the scheduler application may be displayed on the execution screen of the corresponding application.

For example, referring to FIG. 6a, in case an input of dragging a specific memo file M2 among the memo files M1, M2, M3 generated through a memo application into the window icon 2 is received, the controller 180 may group the specific memo file M2 into the first category.

Also, for example, referring to FIG. 6b, in case an input of dragging a specific image I2 among the images I1, I2, I3, I4 captured by executing a gallery application into the window icon 2 is received, the controller 180 may group the specific image I2 into the first category.

Also, for example, referring to FIG. 6c, in case an input of dragging contents 23 provided through a predetermined web-page by executing the Internet into the window icon 2 is received, the contents 23 may be grouped into the first category.

Also, for example, referring to FIG. 6d, in case a specific event 24 among various events registered in the SNS is dragged to the window icon 2 by executing an SNS application, or a button indicating the user's interest regarding the specific event 24 is selected, the SNS event may be grouped into the first category. At this time, in the case of the SNS event, if date and time corresponding to the predetermined event is specified, the event may be classified into the first category, but may be excluded in the absence of schedule information.

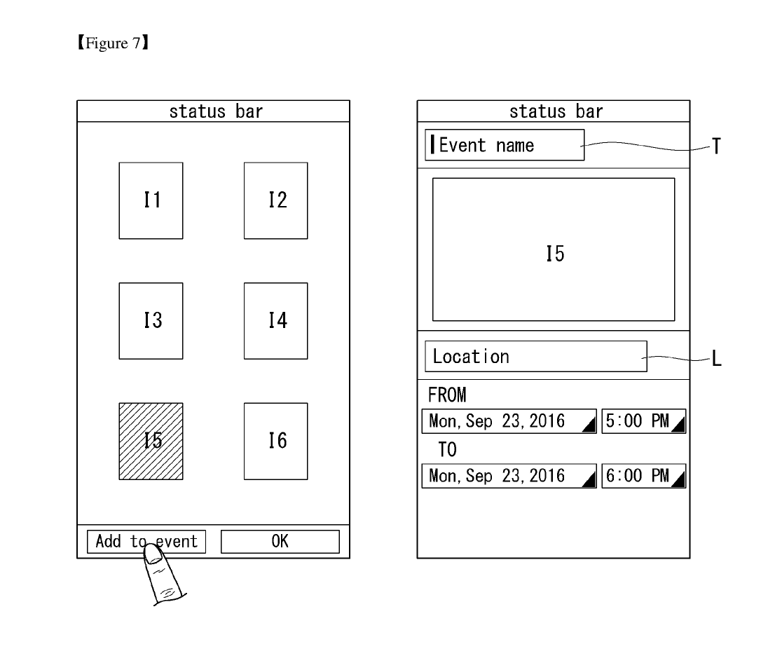

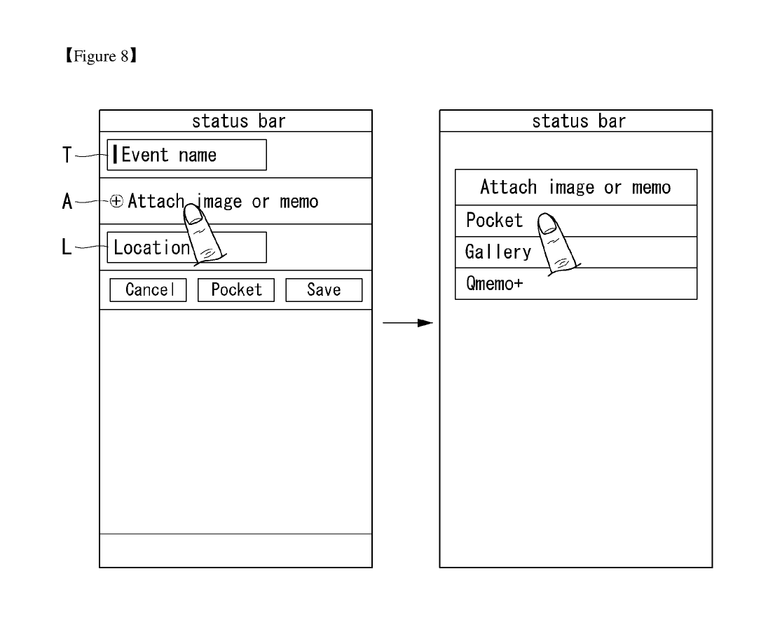

FIGS. 7 to 8 illustrate an example of a procedure for adding an event to a scheduler according to one embodiment of the present invention.

Referring to FIG. 7, as shown in FIG. 5, in case an input selecting a second event E2 from the window W recommending an event to be registered in the scheduler is received, the controller 180 according to one embodiment of the present invention displays a screen corresponding to the second event on the touch screen 151. Afterwards, in case an input for an event-add button is received, the controller 180 may provide the touch screen 151 with an interface providing specific schedule configuration items for adding the second event E2 to the scheduler.

The interface may provide an area T in which the user may enter the title of the corresponding event, an area L in which the user may enter location of the mobile terminal 100, and an area in which the user may enter the start time and the end time of an event.

Meanwhile, referring to FIG. 8, in case a button for attaching a file to the event to be registered in the scheduler is selected from the interface providing the specific schedule configuration items, a category menu showing the location of the attach file may be displayed on the touch screen 151. The category menu may include pocket item including the events grouped by the user, gallery item, memo item, and so on. If the pocket item is selected, related contents may be provided so that the event grouped by the user may be additionally attached.

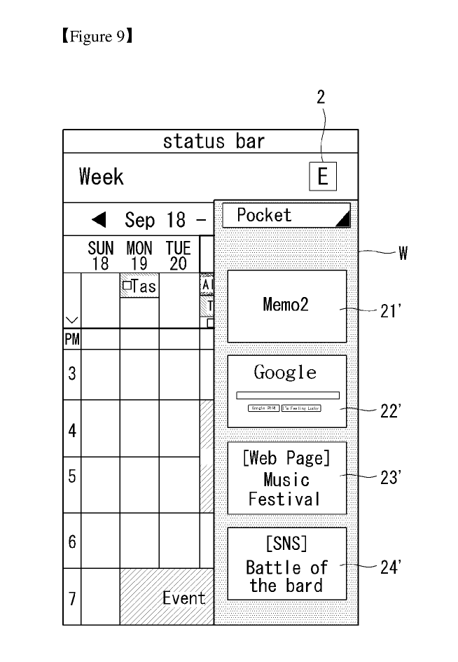

FIG. 9 illustrates an example of displaying grouped items of FIG. 6 together with a scheduler.

Referring to FIG. 9, in case the window icon 2 is selected from the scheduler screen while the events to be added to the scheduler are grouped in advance as illustrated with reference to FIGS. 6a to 6d, the controller 180 may provide the pre-grouped first 21′, second 22′, third 23′, and fourth event 24′ by including them in the window W.

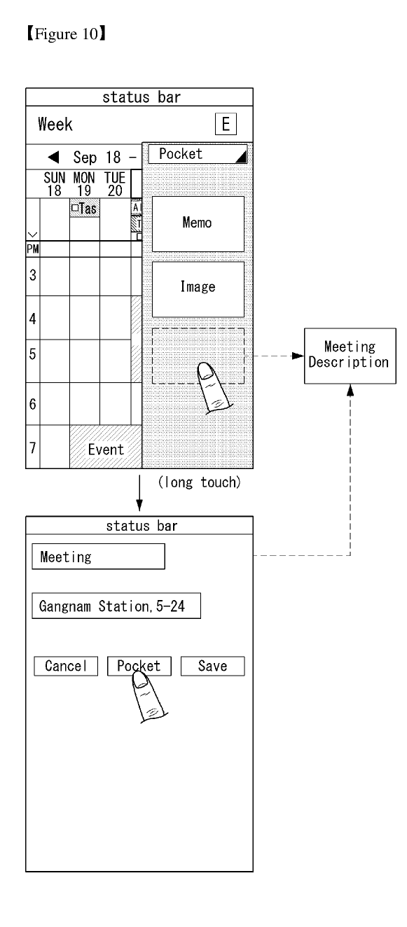

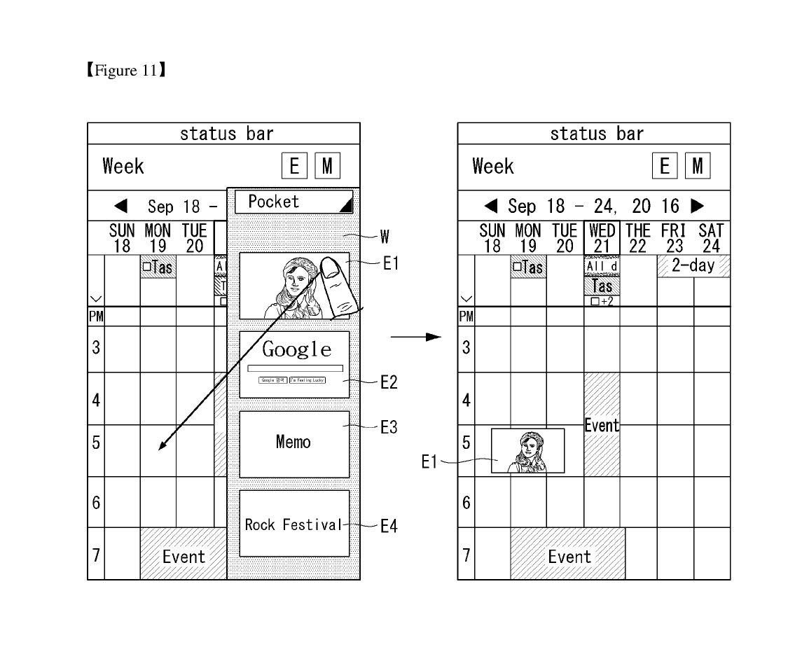

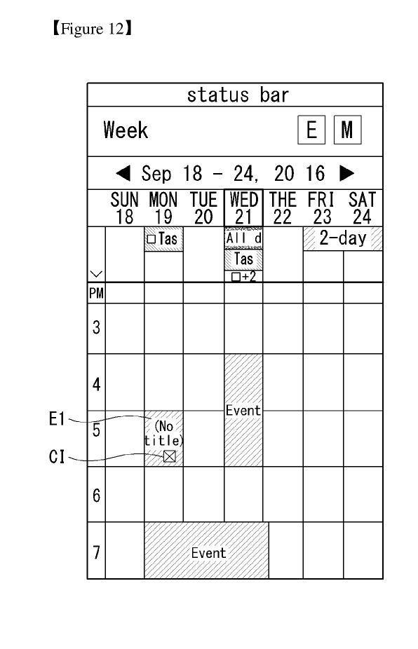

FIG. 10 illustrates another example of generating an event to be added to a scheduler according to one embodiment of the present invention.

Meanwhile, referring to FIG. 10, while the scheduler is executed and the window W according to one embodiment of the present invention is provided, an event to be added to the scheduler may be generated through the window W. For example, in case a long-touch input is received from an empty space of the window W, the controller 180 may provide an interface for generating a new event. The event may include an event title, event area, and category selection menu by which to store a generated event temporarily before adding the event to the scheduler.

If a new event is generated through the interface, the controller 180 may display a thumbnail image corresponding to the newly generated event by adding the thumbnail image on the window W.

FIGS. 11 to 12 illustrate an example of registering an event of a first category to a scheduler according to one embodiment of the present invention.

FIGS. 7 and 8 illustrate an example in which the user registers a predetermined event in the scheduler through an interface through which the user manually registers an event title, event attach file, event start time, and event end time. However, according to one embodiment of the present invention, as shown in FIG. 11, an event included in the window W may also be registered by dragging the event to the scheduler.

Referring to FIG. 11, in case an input dragging a first event El included in the window W to a specific schedule of the scheduler (for example, PM 5:00, September 19) is received, the controller 180 may add the first event E1 to the specific schedule.

In case a long touch input for the first event E1 is received, the controller 180 makes the window W disappear while retaining the selection of the first event E1. Also, in case an input dragging the first event E1 to the specific schedule while the selection is retained is received, the controller 180 may display a graphic object E1 corresponding to the first event E1 at the corresponding schedule of the scheduler.

Referring to FIG. 12, the controller 180 may display, together with the graphic object E1, an indicator CI which allows registration of the event to be cancelled for a predetermined time period after the first event E1 is dragged into the specific schedule of the scheduler.

For example, in case the original schedule of the first event E1 overlaps a different schedule registered in the scheduler, registration of the first event E1 may be cancelled. Also, for example, in case the first event E1 is an event corresponding to a past schedule with respect to the current time, the controller 180 may display a predetermined cancellation indicator (CI) so that the pre-registered event may be cancelled.

Up to this point, a procedure of adding an event pre-grouped by the user to the scheduler has been described. In what follows, a procedure of adding to the schedule contents provided by a different application linked to the scheduler according to one embodiment of the present invention will be described.

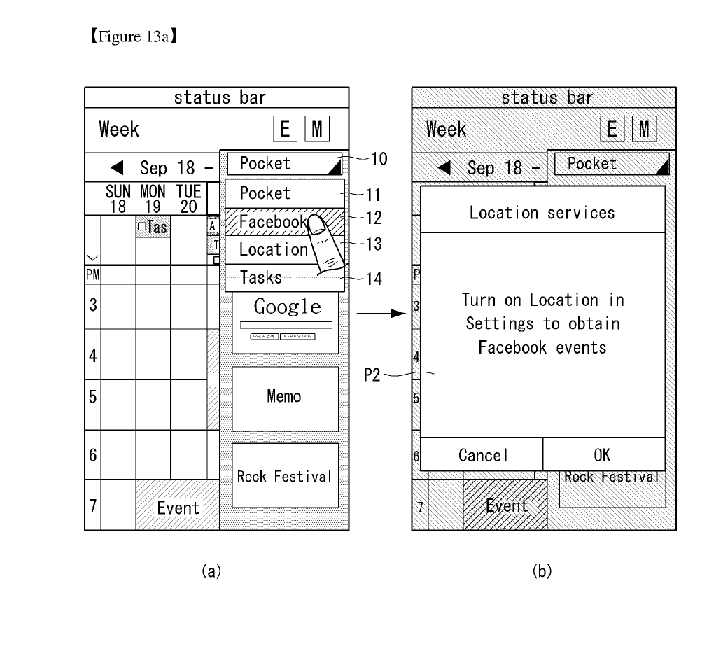

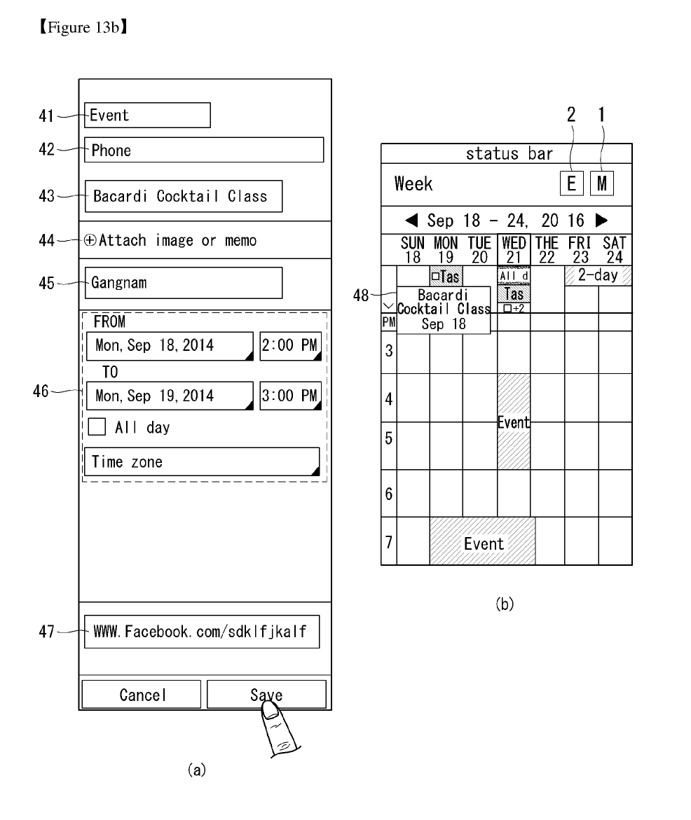

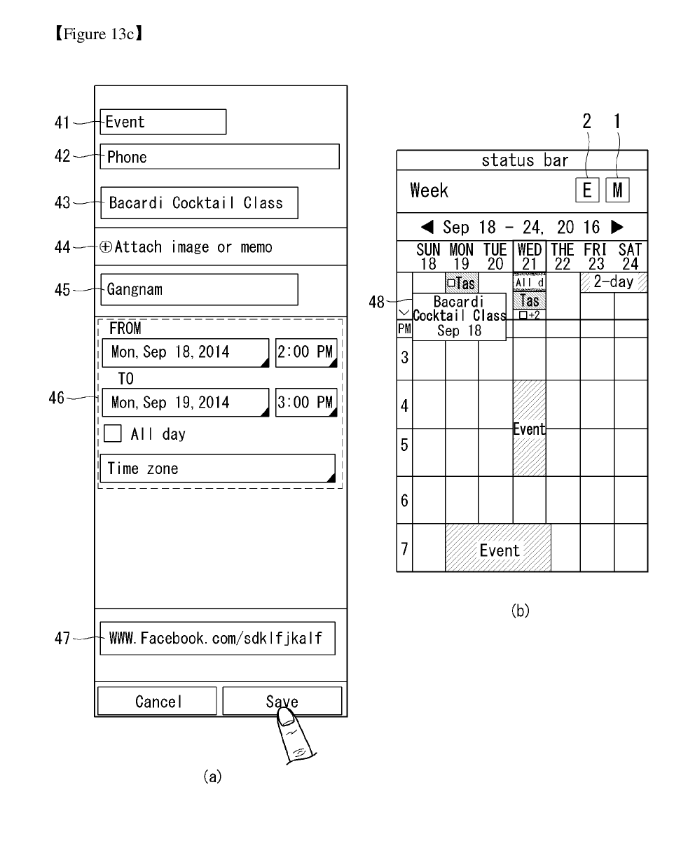

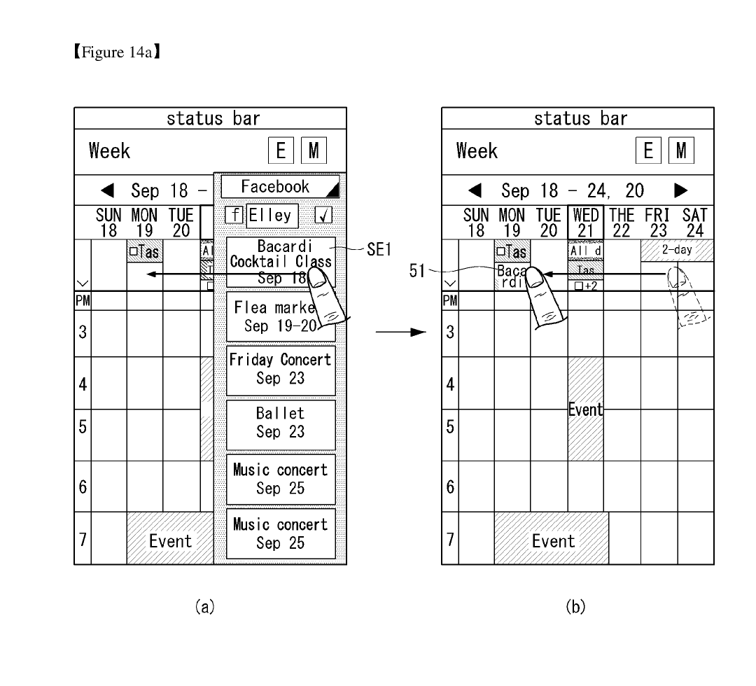

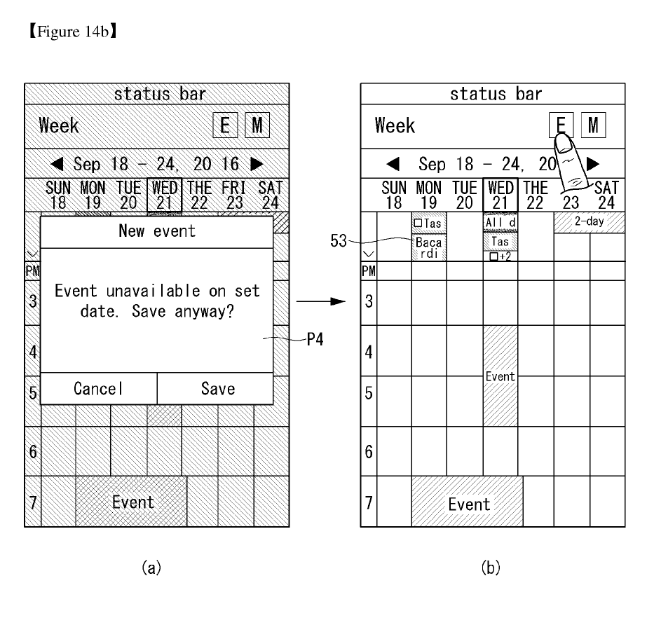

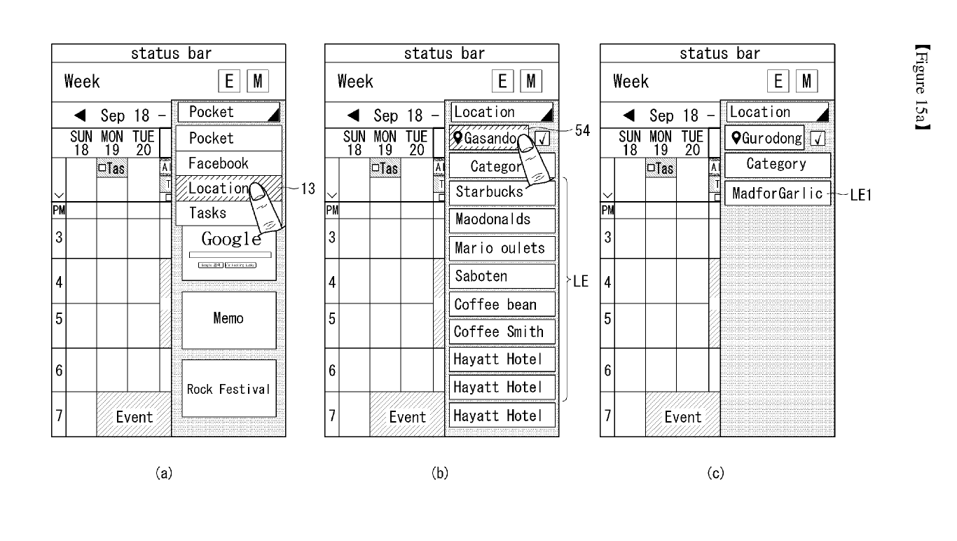

FIGS. 13a to 14b illustrate an example of registering an event of a second category to a scheduler according to one embodiment of the present invention.

Referring to FIG. 13a, as described above, the window W provided on the scheduler screen may provide the source of at least one event that may be registered to the scheduler in a category.

The controller 180 receives an input selecting a second category 12 related to an SNS event. An SNS application may provide events registered by the users of the SNS application according to location information. In case a second category is selected, and the user wants to obtain an SNS event based on location information, a pop-up window P2 inducing activation of a location information module may be provided.

Referring to FIG. 13b, as the second event 12 is selected, the controller 180 may display an event recommended by SNS (SE) on the window W. The window W may display the SNS ID 17 of the user of the mobile terminal 100 together with the SNS event.

The first SNS event SE1 may include information about event theme T1 and event schedule S1. The remaining SNS events may also include the same information.

In case an input selecting the first SNS event SE1 is received, the controller may display a pop-up window P3 for displaying detailed information of the first SNS event SE1 on the touch screen 151.

The pop-up window P3 may include start and end time of an event 31, an icon 32 for checking the event place, a web-page address related to the event 33, a menu 34 for adding the event to the scheduler, a menu 35 for returning to the previous screen, and so on.

If the icon 32 for checking the event place is selected, the controller 180 may execute a map application and display location information of the corresponding place on the map. Also, if the web-page address 33 related to the event is selected, the controller 180 may access the web-page to provide the screen of the web-page. In other words, before adding a predetermined SNS event to the scheduler, the controller 180 may check detailed information of the corresponding SNS event.

In case a menu 34 for adding the SNS event to the scheduler is selected from the pop-up window P3, as shown in FIG. 13, a configuration interface for registering the SNS event to a specific schedule of the scheduler may be provided to the touch screen 151.

Meanwhile, the SNS event theme (title) 43 and the SNS event place 45 may be set automatically.

Meanwhile, the reference number 41 is an indicator indicating that an event is registered in the scheduler, which may be used to distinguish registration of an event from registration of a personal schedule to the scheduler. Also, the reference number 42 is an indicator indicating the electronic device that has last accessed the corresponding SNS. In other words, these indicators are introduced because a specific SNS service may be accessed from a plurality of devices through the same account. In case the user wants to add an SNS event to the scheduler together with an attachment file, the reference number 44 may be used to approach a predetermined path for contents (item) and select contents to be added. The reference number 46 is an SNS event time, into which the unique schedule of the SNS event is automatically input, or the user may set the start and end time of the SNS event. The reference number 47 is an URL address related to the SNS event.

If a storage button is selected from the configuration interface for registering the SNS event, as shown in FIG. 13(b), a graphic object 48 corresponding to the SNS event SE1 that the user wants to add may be displayed at the specific schedule of the scheduler. The graphic object 48 may be displayed as a proportional length corresponding to a period starting from September 18, PM 2:00, which is the event setting time, to September 19, PM 3:00.

FIG. 13c illustrates a procedure for registering an SNS event to the scheduler through a configuration interface for registering an SNS event from the window W according to one embodiment of the present invention; however, in the case of FIG. 14a, an SNS event may be added to a specific schedule of the scheduler by using only a dragging input without involving the configuration interface for adding an event to the scheduler as described above. In other words, referring to FIG. 14a, in case a first SNS event SE1 displayed on the window W is selected, the window W disappears, and the scheduler may fill the whole screen.

If an input dragging the selected first SNS event SE1 to the specific schedule (September 18) of the scheduler is received, the controller 180 determines whether the first SNS event SE1 may be added to the specific schedule 51 of the scheduler. In other words, since the schedule of the first SNS event SE1 is September 18, and the schedule of the dragged scheduler is September 19, the controller 180 determines that the first SNS event SE1 may not be added to the corresponding schedule of the scheduler and as shown in FIG. 14b, may display the pop-up message P4 on the touch screen 151. The pop-up message P4 includes an event addition cancel item and store item; if the store item is selected even though an event may not be added to a selected schedule of the scheduler due to the schedule of the event, the controller 180 may display an object 53 corresponding to the first SNS event at the corresponding schedule of the scheduler.

It should be noted, however, that in case a schedule selected from the scheduler does not match the schedule of an event to be added, an indicator used to cancel event addition may be temporarily displayed together with the object 53.

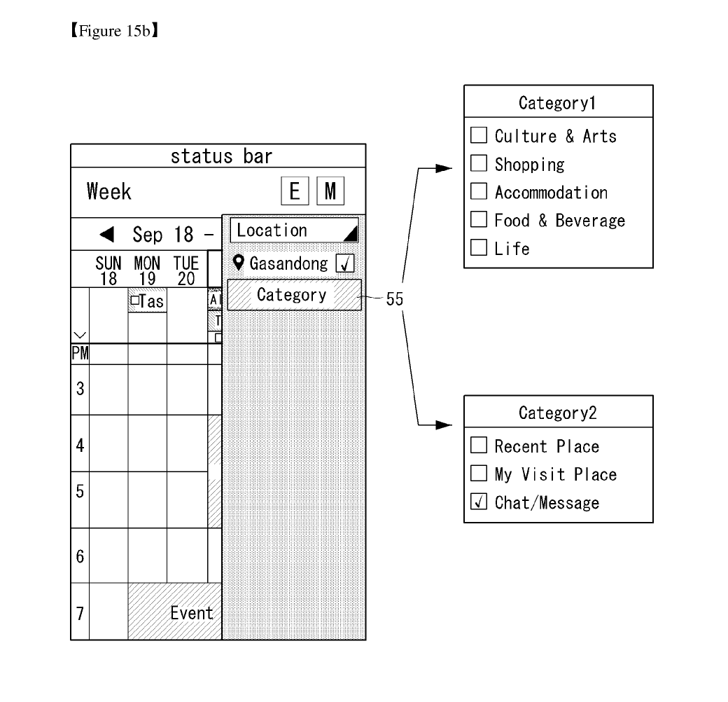

FIGS. 15a to 17b illustrate an example of registering an event of a third category to a scheduler according to one embodiment of the present invention.

The third category includes location-based events through the location information module of the mobile terminal 100.

Referring to FIG. 15a, in case a third category 13 is selected from the window W displayed together with the scheduler, the controller 180 may provide a location setting item 54 and a category item 55 for setting a category for the event to be provided at the set location to the window W.

In case the current location is selected from the location-setting item 54, the controller 180 may provide the window W with event information corresponding to the pre-set category based on the current location. In the case of FIG. 15a, if the current location is set as Gasandong, an event LE based on the Gasandong location may be provided; if the current location is set as Gurodong, an event LE1 based on the Gurodong location may be provided.

Referring to FIG. 15b, the user may set a desired location by using the location-setting item 54 and set the category of an event that the user wants to have at the corresponding location through the category item 55. For example, as shown in FIG. 15b, the category may comprise culture & arts, shopping, accommodation, food & beverage, life, and so on; if at least one category is selected from the plurality of categories, location-based event information belonging to the corresponding category may be provided on the window W.

Also, for example, the category may include recent place items of the mobile terminal 100, my visit place items, chat/message items, and so on. At this time, the chat/message may be provided by extracting location-related conversation from the conversation with a chatting party.

Also, for example, location-based events may be provided as a predetermined SNS application figures out the current location of the mobile terminal 100, and information of events that may be executed within a distance of 1 km from the current location is arranged according to a predetermined order. The predetermined criterion may be determined according to the user's interest derived by analyzing the history of search, browsing, and application installation conducted by the user using the mobile terminal 100.

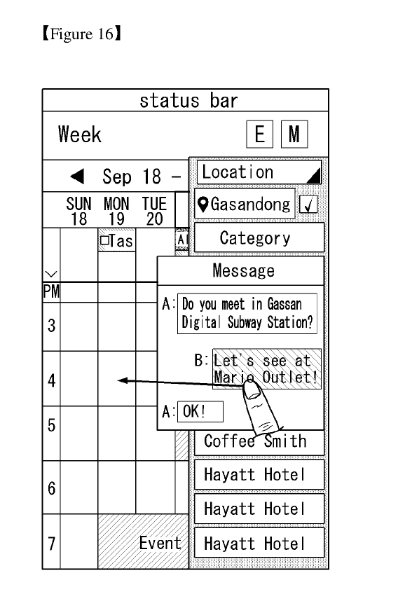

Referring to FIG. 16, in case a chatting item is selected, the controller 180 may provide a mini-message window to the display unit 151 while the scheduler screen is displayed on the display unit 151. In case an input dragging a conversation including location information (for example, Mario outlet) from among conversations listed in the mini-message window into the scheduler screen is received, the controller 180 may recommend event information that may be added to the scheduler according to the location included in the conversation. Similarly, in case an input dragging the conversation to a specific schedule of the scheduler is received, the controller 180 may automatically register the location included in the conversation as the event place.

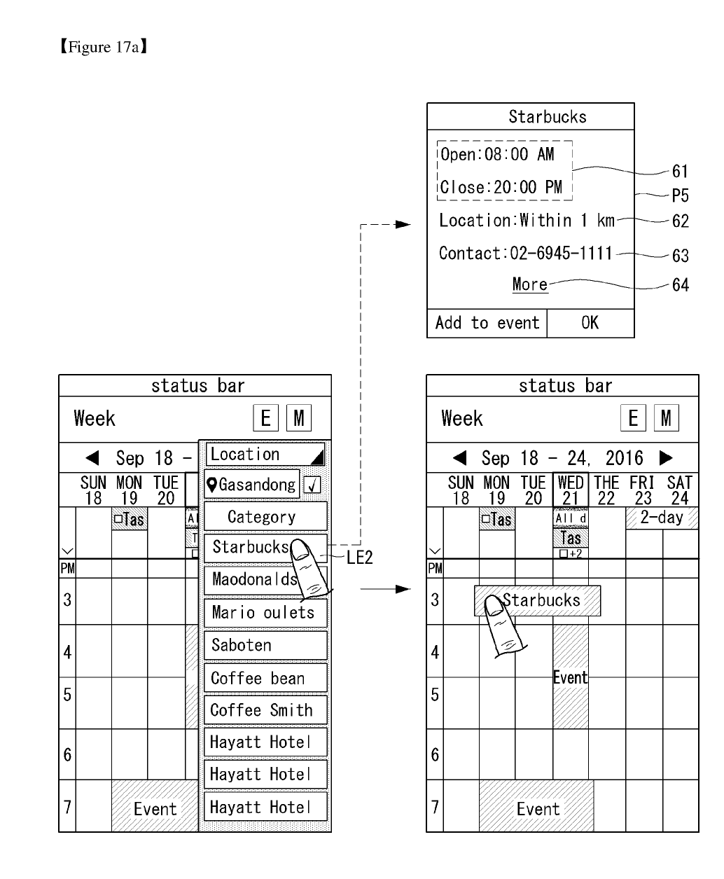

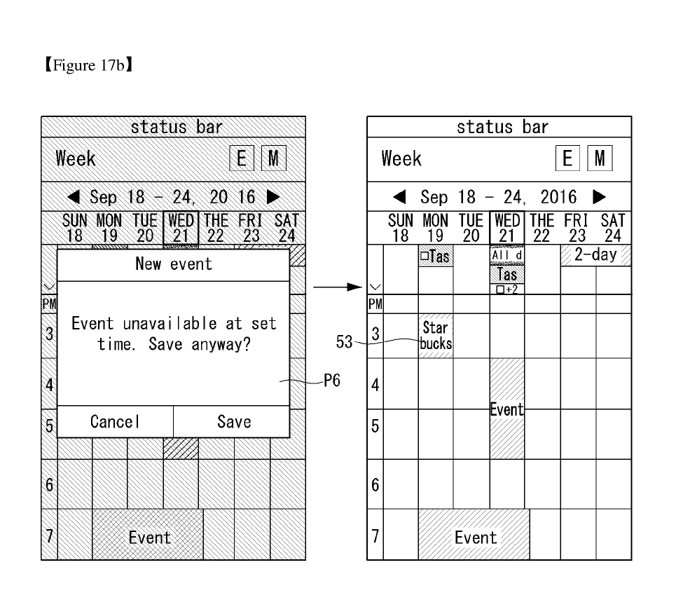

Referring to FIG. 17a, in case a specific location event LE2 is selected in the window W from location events recommended based on the location information, the controller 180 may provide detailed information P5 of the selected specific location event LE2.

For example, in case the specific location event LE2 is related to a shop in the vicinity of the specific location, opening hour information 61, accurate location information 62, phone number 63, and web-page address 64 of the corresponding shop may be provided.

Meanwhile, in case a long-touch input is received with respect to the specific location event LE2 in the window W, the window W disappears while the specific location event LE2 is selected; in case an input dragging the selected event LE2 to a specific schedule of the scheduler is received, an object corresponding to the selected event LE2 may be tagged to a specific schedule of the scheduler. The tagging indicates that the specific event has been added to the scheduler.

Referring to FIG. 17b, in case it is determined that adding an event to the schedule is impossible considering the opening hours of the shop recommended based on location information and the time registered in the scheduler, the controller 180 may inform of the finding through a pop-up message P6.

Meanwhile, the user may add an event to the scheduler even though the event may not be performed. In other words, FIG. 17b shows that an event is registered 53 to use a shop at the time the shop is closed for business.

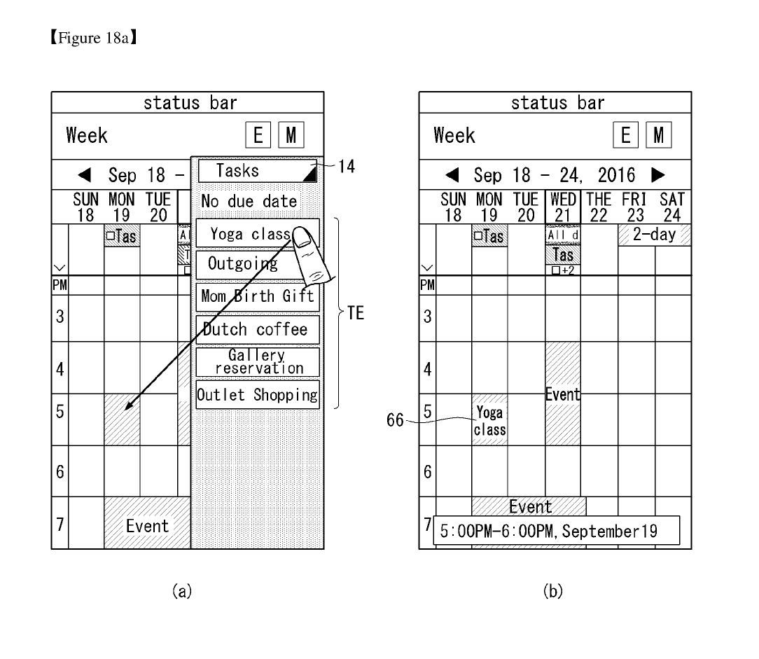

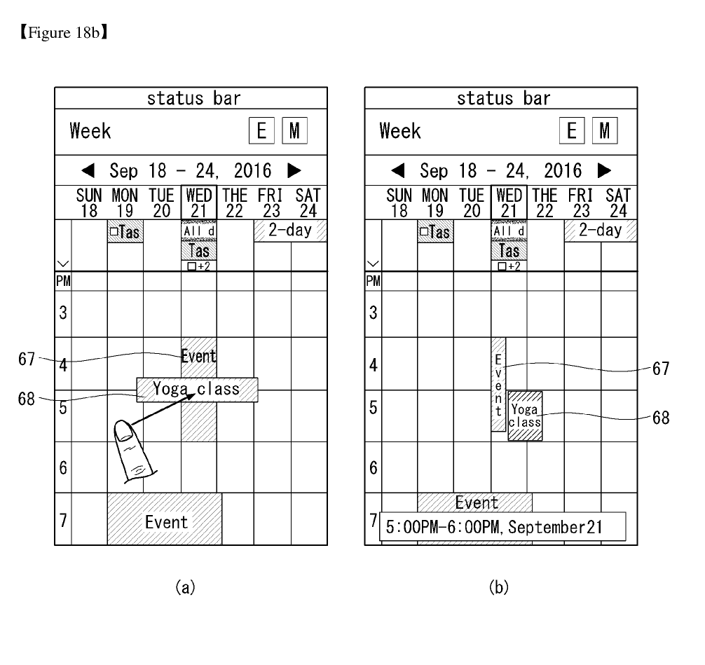

FIGS. 18a to 18b illustrate an example of registering an event of a fourth category to a scheduler according to one embodiment of the present invention.

Referring to FIG. 18a, the fourth category among event categories provided to the window W according to one embodiment of the present invention may comprise tasks that do not have schedule information. The tasks may correspond to a To-Do list that the user generates. The user may provide through the window W tasks not assigned to specific schedules (date and time) such as yoga class, outgoing, mom's birthday, and gallery reservation.

In case an input selecting the Tasks category 14 from the window W is selected, the controller 180 may display the pre-stored task events TE on the window W. The procedure for adding a specific task to the scheduler is the same as described above. If a specific task is registered to a specific schedule (MON 19, PM 5) of the scheduler, an object 66 corresponding to the specific task may be displayed at the corresponding schedule.

Accordingly, according to one embodiment of the present invention, the user may manage the events that do not have schedule information as if having schedules by associating the tasks with the scheduler. Meanwhile, in the case of a task that do not have schedule information, even if the task is registered to the scheduler with a first schedule, it may be changed to a task having a second schedule.

For example, referring to FIG. 18b, while a yoga class is registered as a first schedule (MON 19, PM 5), if an input dragging an object 68 corresponding to the yoga class to a second schedule (WED 21, PM 5) is received, the schedule of the yoga class event may be changed.

Meanwhile, if detailed information of the event related to the yoga class includes contact information (phone number and the like) of a person who manages the yoga class, the controller 180 may reflect a schedule change due to the dragging input and transmit a message for the schedule change to the manager of the yoga class.

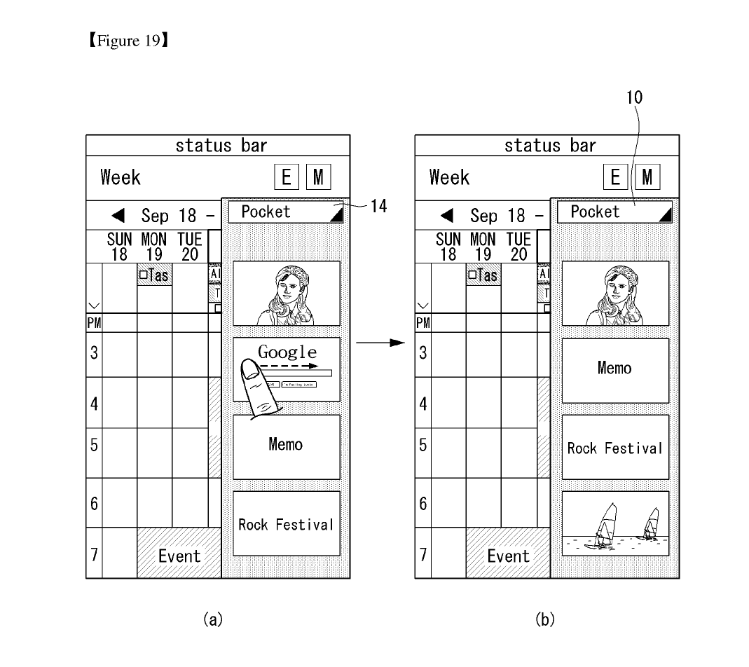

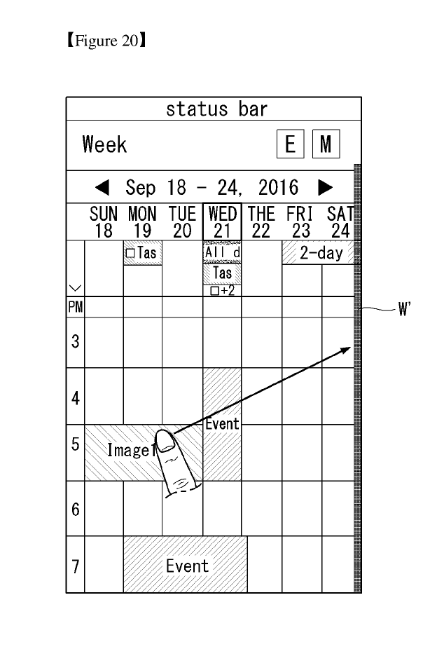

FIGS. 19 to 20 illustrate an example of editing an event to be added to a scheduler or an event registered to the scheduler according to one embodiment of the present invention.

Referring to FIG. 19, the window W according to one embodiment of the present invention includes a plurality of events to be added to the scheduler and in case an input flicking a specific event from among the plurality of events, may remove the specific event from the window W.

Referring to FIG. 20, the window W provided according to one embodiment of the present invention may be displayed in the form of a bar by being slid from one side of the touch screen 151. The sliding window W may obscure the scheduler screen; thus, in case a flicking input is received in the opposite direction of the sliding direction of the window W, the controller 180 may control the window W so that it may be displayed W′ to minimize its occupation area on the side surface of the touch screen while the window W is kept to be active on the scheduler screen. In this case, the window W′ does not display the events to be added to the scheduler.

Meanwhile, in case a dragging input moving a specific event Image 1 added to the scheduler to the window W′ is received, the controller may delete the added event from the scheduler. Accordingly, in the editing process including adding or deleting an event to and from the scheduler, the user may edit the schedule more easily through interaction with the window W provided according to the present invention without involving a separate configuration window.

Various embodiments may be implemented using a machine-readable medium having instructions stored thereon for execution by a processor to perform various methods presented herein. Examples of possible machine-readable mediums include HDD(Hard Disk Drive), SSD(Solid State Disk), SDD(Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1-12. (canceled)

13. A mobile terminal, comprising:
a touchscreen;
a memory for storing at least one event;
a controller configured to:
cause the touchscreen to display a scheduler of an executing a scheduler application;
cause the touchscreen to display a window for recommending the at least one event that is available for registering in the scheduler in response to an input, wherein at least part of the window overlaps the scheduler;
receive an input associating a specific event from among the at least one event with the scheduler; and
register the specific event with a specific schedule of the scheduler.

14. The mobile terminal of claim 13, wherein each of the at least one event includes at least one of an image, a web page, or a memo, and the least one event is stored in a folder.

15. The mobile terminal of claim 13, wherein the window is displayed at one side of the touchscreen, wherein the controller is further configured to:
cause the touchscreen to stop the displaying of the window when an input selecting the specific event from among the at least one event displayed on the window is received; and
matching and registering the specific event to the specific schedule of the scheduler when an input dragging the specific event is received.

16. The mobile terminal of claim 13, wherein the at least one event that is available to be register in the scheduler corresponds to event information including a schedule.

17. The mobile terminal of claim 16, wherein the scheduler includes a calendar-type interface, wherein the controller is further configured to:
register the specific event to the schedule corresponding to the specific event through the calendar-type interface in response to receiving an input moving the specific event from among the at least one event to the scheduler.

18. The mobile terminal of claim 16, wherein the controller is further configured to:
cause the touchscreen to display a pop-up message notifying that the specific event is not registered when an event of a past schedule with respect to a current time is registered to the specific schedule of the scheduler; and
cause the touchscreen to display an indicator for deleting the registered specific event when an event of the past schedule is registered with the scheduler.

19. The mobile terminal of claim 13, wherein the window categorizes source of the at least one event that may be registered to the scheduler, wherein the source includes a first category including the at least one event grouped by a user, a second category including an social networking service (SNS), a third category providing an event based on location information, and a fourth category including a task generated by the user.

20. The mobile terminal of claim 19, wherein the controller is further configured to:
store a first event in the memory by classifying the first event with the second category when a first event registered with the SNS is selected by the user as an event.

21. The mobile terminal of claim 19, wherein the controller is further configured to:
extract an event from among the at least one event uploaded to the SNS and display the extracted event in the window.

22. The mobile terminal of claim 13, wherein the controller is further configured to:
delete the registered specific event from the specific schedule in response to an input dragging the registered specific event into the window.

23. A scheduling method performed by a mobile terminal having a touchscreen and memory, the method comprising:
displaying, on the touchscreen, a scheduler of an executing a scheduler application;
displaying, on the touchscreen, a window for recommending the at least one event that is available for registering in the scheduler in response to an input, wherein at least part of the window overlaps the scheduler;
receiving an input associating a specific event from among the at least one event with the scheduler; and
registering the specific event with a specific schedule of the scheduler.

24. The method of claim 23, wherein each of the at least one event includes at least one of an image, a web page, or a memo, and the least one event is stored in a folder.

25. The method of claim 23, wherein the window is displayed at one side of the touchscreen, wherein the method further comprises:
stopping the displaying of the window when an input selecting the specific event from among the at least one event displayed on the window is received; and
matching and registering the specific event to the specific schedule of the scheduler when an input dragging the specific event is received.

26. The method of claim 23, wherein the at least one event that is available to be register in the scheduler corresponds to event information including a schedule.

27. The method of claim 26, wherein the scheduler includes a calendar-type interface, wherein the method further comprises:
registering the specific event to the schedule corresponding to the specific event through the calendar-type interface in response to receiving an input moving the specific event from among the at least one event to the scheduler.

28. The method of claim 26, wherein the method further comprises:
displaying, on the touchscreen, a pop-up message notifying that the specific event is not registered when an event of a past schedule with respect to a current time is registered to the specific schedule of the scheduler; and
displaying, on the touchscreen, an indicator for deleting the registered specific event when an event of the past schedule is registered with the scheduler.

29. The method of claim 23, wherein the window categorizes source of the at least one event that may be registered to the scheduler, wherein the source includes a first category including the at least one event grouped by a user, a second category including an social networking service (SNS), a third category providing an event based on location information, and a fourth category including a task generated by the user.

30. The method of claim 29, wherein the method further comprises:
storing a first event in the memory by classifying the first event with the second category when a first event registered with the SNS is selected by the user as an event.

31. The method of claim 29, wherein the method further comprises:
extracting an event from among the at least one event uploaded to the SNS and displaying the extracted event in the window.

32. The method of claim 23, wherein the method further comprises:
deleting the registered specific event from the specific schedule in response to an input dragging the registered specific evet into the window.
